(19) United States
(12) Patent Application Publication
(10) Pub. No.: US 2014/0135466 A1
(43) Pub. Date: May 15, 2014

(54) Di-(tert-butyl cyclohexyl) peroxydicarbonate composition

(71) Applicants: Frederik Willem Karel Koers, Epse (NL); Francisca Anna Maria Veldkamp-Groot Koerkamp, Deventer (NL)

(72) Inventors: Frederik Willem Karel Koers, Epse (NL); Francisca Anna Maria Veldkamp-Groot Koerkamp, Deventer (NL)

(73) Assignee: Akzo Nobel Chemicals International B. V., Amersfoort (NL)

(21) Appl. No.: 14/232,329

(22) PCT Filed: Jul. 19, 2012
(86) PCT No.: PCT/EP2012/064132

§ 371 Date: Jan. 13, 2014

Related U.S. Application Data
(60) Provisional application No. 61/511,179, filed on Jul. 25, 2011.

(30) Foreign Application Priority Data
Jul. 22, 2011 (EP) 11175032.9

(51) Int. Cl. C08K 5/14

(52) U.S. Cl. CPC C08K 5/14
USPC 526/328; 252/182.23; 526/319

(57) ABSTRACT

Process for the preparation of a composition comprising di-(tert-butylcyclohexyl) peroxydicarbonate comprising the steps of (a) preparing a pre-mix comprising di-(tert-butylcyclohexyl) peroxydicarbonate, one or more organic solvents, a hydrophilic silica, and apolyalkoxylated butyl ether, and (b) milling the pre-mix resulting from step (a).

The present invention relates to di-(tert-butylcyclohexyl) peroxydicarbonate suspensions, their use and their preparation.

Di-(tert-butylcyclohexyl) peroxydicarbonate is solid at room temperature and tends to be rather dusty and, therefore, difficult to handle. As a result, this peroxide is preferably handled in the form of a suspension and/or paste instead of its pure form. WO 2008/125591 discloses 40 wt % di-(tert-butylcyclohexyl) peroxydicarbonate suspensions comprising polyethylene glycol, (di-)ethylene glycol, and a silica (Aerosil 200).

In order to prepare such compositions, intensive milling is required, which results in a significant temperature increase of the composition. As is well-known, peroxides are thermally labile organic compounds. Because the decomposition of peroxide is exothermic, it is hazardous when the heat of decomposition cannot be dissipated, e.g., by heat loss to the surrounding area. When heat build-up occurs, the decomposition reaction eventually becomes uncontrollable and potentially dangerous.

It has now been found that this temperature increase can be reduced if a non-ionic surfactant is added to the suspension during its preparation. Without being bound to theory, it is believed that this effect is caused by the viscosity-reducing effect of the surfactant.

The invention therefore relates to a process for the preparation of a suspension comprising di-(tert-butylcyclohexyl) peroxydicarbonate comprising the steps of:

a) preparing a pre-mix comprising di-(tert-butylcyclohexyl) peroxydicarbonate, one or more organic solvents, a hydrophilic silica, and a polyalkoxylated butyl ether, and

b) milling the pre-mix resulting from step a).

The invention also relates to a peroxide composition comprising di-(tert-butylcyclohexyl) peroxydicarbonate, silica, one or more organic solvents, and a polyalkoxylated butyl ether.

The peroxide is preferably present in the composition of the invention in an amount of at least 10 wt %, more preferably at least 15 wt %, even more preferably at least 20 wt %, and most preferably at least 30 wt %, based on the total weight of the composition, and generally at most 90 wt %, preferably at most 70 wt %, and most preferably at most 50 wt %, based on the total weight of the composition.

A hydrophilic silica is defined as a silica which has not been treated with organic compounds to increase its hydrophobicity. Examples of such silicas are fumed or pyrogenic silica, precipitated silica, and silica gel.

The silica is preferably used in the process and the composition of the invention in an amount of at least 0.5 wt %, more preferably at least 1.0 wt %, based on the total weight of the composition, and generally of at most 5 wt %, preferably at most 3 wt %, and most preferably at most 2 wt %, based on the total weight of the composition.

The one or more organic solvents used in the process and the composition according to the present invention should be able to disperse the di-(tert-butylcyclohexyl) peroxydicarbonate. Preferably, the organic solvent(s) do/does not dissolve the peroxide.

Preferably, at least one of the organic solvents used comprises at least one hydroxyl group and/or at least one —OR group, wherein R is a substituent comprising from 1 to 20 carbon atoms. The R-group may contain one or more heteroatoms like O, N, or S.

The organic solvent generally does not react with the peroxide or with itself in the presence of the peroxide. For this reason, organic solvents comprising a nitrogen atom are less preferred. Suitable examples of organic solvents include glycols such as ethylene glycol, glycerol, diethylene glycol, dipropylene glycol, polyethylene glycol, and polypropylene glycol; and phosphorus-containing compounds such as diethyl phosphate, dibutyl phosphate, tributyl phosphate, triethyl phosphate, dibutyl phosphite, and triethyl phosphite.

Preferred organic solvents are selected from the group consisting of ethylene glycol, glycerol, diethylene glycol, dipropylene glycol, polyethylene glycol, and triethyl phosphate.

It is also contemplated to use a combination of two or more organic solvents such as the combination of ethylene glycol and polyethylene glycol or the combination or diethylene glycol and polyethylene glycol.

The one or more organic solvents is/are preferably used in the process and the composition of the invention in a total amount of at least 20 wt %, more preferably at least 30 wt %, even more preferably at least 40 wt %, and most preferably at least 50 wt %, based on the total weight of the composition, and generally of at most 90 wt %, preferably at most 70 wt %, and most preferably at most 60 wt %, based on the total weight of the composition.

The peroxide composition of the present invention preferably comprises less than 20 wt % of water, based on the total weight of the composition. More preferably, the composition comprises less than 10 wt % of water, more preferably less than 5 wt %, and most preferably the composition is free of water. The presence of large amounts of water is undesirable in view of some of the applications of the composition: water may influence the curing properties—the compositions may not cure at all—and water may impair the mechanical properties of the resulting polymer. Moreover, water is not compatible with apolar organic polymer systems, and will separate out.

The polyalkoxylated butyl ether is a non-ionic surfactant. Preferably, the polyalkoxylated butyl ether is a polyethoxylated and/or a polypropoxylated butyl ether, more preferably of any of the formulae C₄H₉O—(CH₂CH₂O)ₘ—(CH₂CH(CH₃)O)ₙH, C₄H₉O—(CH₂CH(CH₃)O)ₙ—(CH₂CH₂O)ₘH, C₄H₉O—(CH₂CH(CH₃)O)ₙH and C₄H₉O—(CH₂CH₂O)ₘH, wherein m and n are individually selected from the range 1-20, more preferably 1-5. The total number of alkoxylate groups is preferably at least 2. Most preferably, the polyalkoxylated butyl ether is a polyethoxylated butyl ether. Also mixtures of one or more polyalkoxylated butyl ethers can be used.

The amount of polyalkoxylated butyl ether used in the process and the composition of the present invention preferably ranges from 0.1-5.0 wt %, more preferably 0.2-3.0 wt %, and most preferable 0.3-1.0 wt %, based on the weight of the entire composition.

The amount of polyalkoxylated butyl ether used depends on the desired viscosity of the composition. If the composition is desired to have the form of a paste, the amount of polyalkoxylated butyl ether is preferably in the range 0.1-0.5 wt %, more preferably 0.2-0.4 wt %, based on the weight of the entire composition.

If a less viscous suspension is desired, it is preferred to use about 0.5 wt % or more.

If so desired, additional compounds may be used in the process and the composition according to the present invention. Examples of such compounds include anti-freezing agents, protective colloids, pH-adjusting agents such as calcium oxide or phosphate buffers, sequestering agents, inhibitors, radical scavengers, chain transfer agents, and, if desired, biocides, e.g. fungicides. The concentration of these compounds will depend on the desired effect and the other ingredients in the composition.

Less preferred compounds are phthalates and benzoates like 2-ethylhexyl benzoate, as these generally form an undesirable environmental burden and/or are carcinogenic.

Generally, the additional compounds are present in an amount of at least 0.1 wt %, preferably at least 0.5 wt %, and most preferably at least 1 wt %, based on the total weight of the composition, and generally of at most 20 wt %, preferably at most 10 wt %, and most preferably at most 5 wt %, based on the total weight of the composition.

The first step of the process according to the present invention is the preparation of a pre-mix comprising di-(tert-butylcyclohexyl) peroxydicarbonate, the one or more organic solvents, the silica, the polyalkoxylated butyl ether, and any optional additional compounds.

In a preferred embodiment, the solvent, the silica, and any additional compounds are first mixed to form a homogenous suspension, after which the di-(tert-butylcyclohexyl) peroxydicarbonate is added and mixed to form a homogeneous suspension, followed by the addition of the polyalkoxylated butyl ether.

This preparation of the pre-mix can be done in any suitable mixing apparatus, such as a conical mixer (e.g. a Nauta Mixer), a dissolver, a Drais® mixer, or an Ultra-turrax.

The pre-mix is preferably prepared at room temperature or lower, e.g. −10-25° C., more preferably −5-20° C., and most preferably 0-12° C.

The resulting mixture is then milled. The term “milling” is defined in this specification as a mechanical action resulting in the particle size (d90) of di-(tert-butylcyclohexyl) peroxydicarbonate to be reduced to 200 microns or less, as measured by laser light diffraction using a wet dispersing unit without ultrasonic treatment (e.g. using a Sympatec QUIXEL) in combination with a He—Ne laser (632.8 nm) diffraction sensor (e.g. Sympatec HELOS H0148).

Milling can be performed in various types of mills, including horizontal grinding mills, vertical grinding mills, ball mills, bead mills, sand mills, high-shear mixers, colloid mills, and electrical transducers that can introduce ultrasound waves into a suspension. It is important to control the temperature of the mixture during milling to below 35° C. in order to prevent decomposition of the peroxide.

A preferred type of mill is a dispax® reactor, which is an inline ultra high shear dispersing machine, which contains one or more rotor-stator combinations (generators) in series. In order to control the temperature, the mixture can be cooled during milling. Alternatively, a dispax® reactor with only one rotor-stator combination can be used, and/or the flow through the dispax® is adjusted to achieve this temperature control.

The composition of the present invention can have the form of a paste or of a less viscous suspension/slurry. Pastes generally have a viscosity in the range 10,000-30,000 mPa·s, as measured by a viscosity-rheometer (e.g. Anton Paar Physica-Rheometer type MC100) with a spindle of 31 (50 mm.0°) d=1 mm, a shear rate of 10 s⁻¹, a temperature of 20° C., and 15 min delay.

The less viscous suspensions preferably have a viscosity less than 10,000 mPa·s.

The composition of the invention can be used in polymer modification processes, cross-linking reactions, mass polymerization processes, and curing processes of, for example, unsaturated polyester, vinyl ester, and acrylate resins, including ortho-resins, iso-resins, iso-npg resins, and dicyclopentadiene (DCPD) resins. Examples of such resins are maleic, fumaric, allylic, vinylic, and epoxy-type materials.

In these processes a variety of monomers and/or polymers can be reacted, including, for example, acrylates, vinyl esters, vinyl halides, vinyl ethers, vinyl aromatic compounds, such as styrene, lower alkenes, polybutadiene, unsaturated imides, methacrylate-butadiene-styrene copolymers, and the like.

The composition of the invention is suitably used in mass polymerization processes, and in particular in the curing of unsaturated polyester resins, acrylate, or vinyl ester resins.

### EXAMPLES

### Example 1

The following ingredients are introduced into a conical mixer: 9.36 kg diethyleneglycol, 2.21 kg polyethyleneglycol 200 en 0.36 kg silica (Cab-O-sil® M5).This mixture was stirred for 15 minutes at 20° C.

Di-(tert-butylcyclohexyl) peroxydicarbonate (Perkadox® 16, ex Akzo Nobel; 8.4 kg) was introduced slowly into the mixture within a period of 34 minutes.

After stirring for another 15 minutes, 70 gram Ethylan NS500 LQ (polyalkoxylated butyl ether, ex AkzoNobel) was added, resulting in a visibly lower viscosity within 5 minutes. The resulting mixture was stirred for another 15 minutes at 19° C.

The resulting mixture was cooled to about 8° C. using glycol of −15° C. and the cooled mixture was then milled in a 3-stage Dispax® reactor using a flow rate of 240 kg/hr. This milling resulted in a temperature increase of 26° C., to a stable value of 35° C.

### Example 2

Example 1 was repeated, except that after the addition of the polyalkoxylated butyl ether, the mixture was stirred at 2° C. and this mixture was cooled to −1° C. and then milled. Milling resulted in a temperature increase of 31° C.

### Example 3

Example 1 was repeated, except that 140 g Ethylan NS500 LQ was added to a pre-mix of 1° C. and that milling was performed with a flow rate of 325 kg/h. Milling resulted in a temperature increase of 25° C.; from 1° C. to 26° C.).

### Comparative Example 4

Example 3 was repeated except that no polyalkoxylated butyl ether was added. Milling resulted in a temperature increase of 36° C. (from −6° C. to 30° C.).

### Example 5

Example 3 was repeated except that the temperature of the premix was adjusted to 4° C. and milling was performed using a 1-stage Dispax® reactor. This milling resulted in a temperature increase of only 14° C. (from 2° C. to 16° C.).

### Example 6

Example 3 was repeated except that the temperature of the premix was adjusted to 3° C. and milling was performed using a 2-stage Dispax® reactor. Milling resulted in a temperature increase of 24° C. (from −3° C. to 21° C.).

### Example 7

Example 3 was repeated except that different types of surfactants were used. The viscosity of the resulting pastes was determined by a pourability test. The pourability test consisted of placing 100 g of the paste in an LDPE beaker, turning the beaker upside down for 10 seconds and determining the amount of paste leaving the beaker. If more than 80 wt % of paste left the beaker, the paste was considered ‘pourable’. If 10-80 wt % of paste left the beaker, the paste was considered ‘slightly pourable’. If less than 10 wt % of paste left the beaker, the paste was considered ‘not pourable’ The results are displayed in the Table below and show that for an effective di-(tert-butyl cyclohexyl) peroxydicarbonate paste preparation, a polyalkoxylated butyl ether as non-ionic surfactant is essential.

TABLE 1

| Surfactant: | Chemical description: | Result/Viscosity |
|---|---|---|
| Ethylan NS 500LQ | Polyalkoxylated butyl ether. | pourable |
| Tergitol XD | Polyalkoxylated butyl ether | pourable |
| Ethylan 1206 | Ethoxylated/propoxylated | not pourable |
| | C₁₀₋₁₂ alcohol | |
| Softanol 70 | Ethoxylated C₁₂₋₁₄ alcohol | not pourable |
| Agrilan AEC145 | Di/tristyrylphenol ethaxylate | not pourable |
| | (15 EO) | |
| Brij 96V | PEG 10 oleyl ether | not pourable |
| Tween 40 | Polyoxyethylenesorbitan | not pourable |
| | monopalmitate | |

### Example 8

Example 7 was repeated, except that dibenzoyl peroxide was used instead of Di-(tert-butylcyclohexyl) peroxydicarbonate. None of the surfactants listed above turned out to lower the viscosity in a significant way, i.e. all of the formulations remained ‘not pourable’ as explained in example 7.

1. A process for the preparation of a composition comprising di-(tert-butylcyclohexyl) peroxydicarbonate comprising the steps of:
a) preparing a pre-mix comprising di-(tert-butylcyclohexyl) peroxydicarbonate, one or more organic solvents, a hydrophilic silica, and a polyalkoxylated butyl ether, and
b) milling the pre-mix resulting from step a).

2. The process according to claim 1 wherein the polyalkoxylated butyl ether is a polyethoxylated and/or polypropoxylated butyl ether of any of the formulae C₄H₉O—(CH₂CH₂O)ₘ—(CH₂CH(CH₃)O)ₙH, C₄H₉O—(CH₂CH(CH₃)O)ₙ—(CH₂CH₂O)ₘH, C₄H₉O—(CH₂CH(CH₃)O)ₙH and C₄H₉O—(CH₂CH₂O)ₘH, wherein m and n are individually selected from the range 1-20.

3. The process according to claims claim 2 wherein at least one of the one or more organic solvents comprises at least one hydroxyl and/or at least one —OR group, wherein R is a substituent comprising from 1 to 20 carbon atoms.

4. The process according to claim 3 wherein at least one of the one or more solvents is selected from ethylene glycol, diethylene glycol, and polyethylene glycol.

5. A peroxide composition comprising di-(tert-butylcyclohexyl) peroxydicarbonate, hydrophilic silica, one or more organic solvents, and a polyalkoxylated butyl ether.

6. The peroxide composition according to claim 5 comprising 30-50 wt % di-(tert-butylcyclohexyl) peroxydicarbonate.

7. The peroxide composition according to claim 5 comprising 1-3 wt % hydrophilic silica.

8. The peroxide composition according to claim 5 comprising 50-70 wt % of one or more organic solvents.

9. The peroxide composition according to claim 5 comprising 0.2-0.75 wt % of polyalkoxylated butyl ether.

10. The peroxide composition according to any one of claim 5 wherein the polyalkoxylated butyl ether is a polyethoxylated and/or polypropoxylated butyl ether of any of the formulae C₄H₉O—(CH₂CH₂O)ₘ—(CH₂CH(CH₃)O)ₙH, C₄H₉O—(CH₂CH(CH₃)O)ₙ—(CH₂CH₂O)ₘH, C₄H₉O—(CH₂CH(CH₃)O)ₙH and C₄H₉O—(CH₂CH₂O)ₘH, wherein m and n are individually selected from the range 1-20, more preferably 1-5.

11. The peroxide composition according to any one of claim 5 wherein at least one of the one or more organic solvents comprises at least one hydroxyl and/or at least one —OR group, wherein R is a substituent comprising from 1 to 20 carbon atoms.

12. The peroxide composition according to claim 11 wherein at least one of the one or more solvents is a polyethylene glycol.

13. A mass polymerization process comprising using the peroxide composition according to claim 5 in said mass polymerization process.

14. The process according to claim 13, wherein said mass polymerization process comprises curing an unsaturated polyester, acrylate, or vinyl ester resin.

15. The process according to claim 1 wherein the polyalkoxylated butyl ether is a polyethoxylated and/or polypropoxylated butyl ether of any of the formulae C₄H₉O—(CH₂CH₂O)ₘ—(CH₂CH(CH₃)O)ₙH, C₄H₉O—(CH₂CH(CH₃)O)ₙ—(CH₂CH₂O)ₘH, C₄H₉O—(CH₂CH(CH₃)O)ₙH and C₄H₉O—(CH₂CH₂O)ₘH, wherein m and n are individually selected from the range 1-5.
